(19) United States
(12) Patent Application Publication
(10) Pub. No.: US 2018/0058823 A1
(43) Pub. Date: Mar. 1, 2018

(54) Hybrid Chassis Breaching System

(71) Applicant: Kevin Mark Diaz, Dorchester, MA (US)

(72) Inventor: Kevin Mark Diaz, Dorchester, MA (US)

(21) Appl. No.: 14/962,765

(22) Filed: Dec. 8, 2015

(51) Int. Cl. F41H 11/16; B63G 7/06; F42B 33/06; G01S 5/10

(52) U.S. Cl. CPC F41H 11/16; B63G 7/06; G05B 2219/49157; G01S 5/10; G05B 2219/45083; F42B 33/06

(57) ABSTRACT

A robotic amphibious mine breaching system including a hybrid chassis with deployable Mat Modules provides a detection and navigation grid with breaching mechanisms to range from underwater to edge of shore, the beach and continue inland. A computer-controlled transmitter and receiver unit integrates signals from different spatial locations establishing a grid. The surface and underwater mine counter-measure system deploys transponders and sensors to detect anomalies in the electromagnetic field caused by both magnetic and non-magnetic objects therein during underwater travel creating a cleared navigational grid establishing landing lanes for Force Protection and Maneuver Capabilities.

### BACKGROUND—PRIOR ART

The following is a tabulation of some prior art that presently appears relevant:

| U.S. Patent number | Issue Date | Patentee |
|---|---|---|
| 3,707,913 | March 1973 | Lee |
| 4,674,048 | June 1987 | Okumura |
| 5,159,343 | October 1992 | Harmuth |
| 5,206,640 | April 1993 | Hirvonen et al. |
| 5,598,152 | January 1997 | Scarzello et al. |
| 8,004,816 | August 2011 | Adler |
| 8,578,831 | November 2013 | Adler |

This invention relates to a Hybrid Chassis Breaching System (HCBS). Specific geographic regions of the world need new methods for defeating underground and undersea mines. This hybrid vehicle is especially to be used on existing paths in sand environments worldwide to protect against IED/Mines, a long-time priority issue and establishes an effective tool for safe passage, security monitoring and for creating secure zones. Both the facts of presence of underground mines as well as the importance of deterrence and prevention of positioning new mines are available. The necessity for addressing these issues for dismounted and travel by foot is the focus of this new hybrid breaching system. The invention has the advantage of operating within littoral areas as well as on land. Providing this proposed mobility capability shall permit movement from place to place while using modular fragmentation barriers.

The unfilled need for defeating mines in all environments at sea, in the littoral zone, open fields and trails between villages has always needed methods of solution. As the use of mines was common for numerous years, millions of mines are located and placing an equivalent number of humans at risk. Recent studies have indicated a new degree of effort must be made spent into the success of what is first step to defeat mines that of limiting the placement of them, thus creating the benefit of secure areas. Proactive security and containment is simultaneously performed as the vehicle functions to prevent further placements of mines.

The principal technique to accomplish minesweeping shall employ technology to detect, classify, identify, and neutralize all mine-like contacts found. In all locations the success of neutralization is limited by the acoustics, visibility, and topography of the underwater environments in planned operating areas. This system may easily integrate with air delivered systems to support an overall breaching operations allowing for landings from ship to shore with inland movement and maneuver with the full time capability for breaching of lanes.

So as to achieve this objective in harsh environments and terrain this mobile platform facilitates missions making logistically supportable operations to provide security. This will provide a new force element for establishing and for continued physical security within and between villages or in developing areas. Integrating existing and future screening programs allows for more comprehensive and safer processes. In becoming part of the force structure, this equipment adds function and strength to achieve current and future missions. With basic instruction for operation, communication skills, improvised explosive device detection, biometric identification and checkpoint procedures the defeat system participates by providing simultaneous combined activities. The necessity of having a capable defensive security underlies the ability of a village to protect and sustain itself. Villager and soldier perceptions of security are an important contributing health factor as the nuance of safety is required for stability and growth in the area. The robot machine would integrate well working forward in platoon and squad sized forces. Additional consideration is given toward the positive contributions provided in riot conditions to monitor, assess, contain, capture and control situations which are in areas of immediate importance.

Several previous applications have been filed by the applicant from the previous Continuation-In-Part of application Ser. No. 13/754,317, Continuation-In-Part of application Ser. No. 13/538,068, filed Jun. 29, 2012 now U.S. Pat. No. 8,677,876 which is a Continuation-In-Part of application Ser. No. 13/184,505, filed Jul. 16, 2011 now U.S. Pat. No. 8,240,239. The embodiments contained in those applications present modular solutions for breaching capabilities of minesweepers for detection and neutralization tasks providing a Material Solution for the Validated Requirement for certain service mission uses. This HCBS combines the capability of unmanned ground and surface vehicle applications in one chassis.

The embodiments disclosed in the present application are configured for scalable modular use. These assemblies may be used as mission modules or become an integral part of the chassis or vehicle for the fragmentation barriers, controlled pressure applications, shockwave dissipation and vehicle stability for the mine defeat systems. There are several elements which are additive and independent included for various levels of performance. The particular machine described in this application is presented in its best mode for a breaching system able to perform tasks on land and in water as described in the specification. Synergy exists in the assembly of apparatus by first being blast triggered by the closer initial offset distance towards the mounted blast plate at the rear of assembly which is strut mounted to the vehicle platform. Each strut connection may have a flexible joint with limited rotation. The pressure field is relieved and dissipated by the system of energy absorbing struts, billows curtains and expanding canopy. The machine reacts as the pressure is relieved in the pressure wave direction and each side functioning as a dissipating containment system.

This equipment clears a minimum, substantial 32 inch wide path, for personnel and is a modular scalable solution for establishing safe pathways with detection, verification, sensors, surveillance, disarming, detonation, containment and path marking all in one process. This method of defeating a mine keeps people and personnel at a distance from the hazard with prevention, simultaneously. Pressure wave, fire and fragmentation from all mines occur within milliseconds of triggering the device and it is necessary to defeat this type of device from placement to containment, specifically anti-personnel type mines. The one vehicle makes available the necessary functions of soft protection methods and direct mechanized and energy breaching means. This addresses the two-part problem of mines, protection from initial placement while also providing safe detection, removal and containment, a combined comprehensive approach to defeating mines.

### SUMMARY

It is the objective of the present invention to create a new hybrid chassis breaching system. Technologies are sought for operational needs combining the ability to move and maneuver with force protection and mission reliability coming out of the water and to advance on land.

Some of the key definitions and Joint Capability Attributes are mobility, a quality or capability of military forces, which permits them to move from place to place while retaining the ability to fulfill their primary mission. Protection is the ability to defeat attacks. Defeat Explosive Hazards is the ability to locate and neutralize the full range of enemy and friendly explosive hazards that may impede routine operations, decrease mobility or present a threat to force protection. The proposed system provides capabilities to detect, avoid, and neutralize hazards in concert with dismounted maneuver breach with the benefit enhancing mobility for tactical movement complex obstacles without loss of speed or flexibility. The proposed hybrid chassis is both an unmanned ground vehicle (UGV) and surface unmanned vehicle (SUV) category unmanned vehicle for maneuvering on the water surface.

The technology through its' embodiments integrates Force Protection for detecting and neutralizing explosive hazards, including mines, improvised explosive devices, unexploded ordnance, and explosive remnants of war and further combines Maneuver abilities to overcome explosive ground obstacles from the seaward approach when they cannot be by-passed. Whether on breaching on land or breaching lanes while landing, having Force Protection with fragmentation Barriers synchronizes movement and maneuver operational needs. This technology has been developed to close these various capability gaps and provide the abilities to conduct amphibious landings in littoral terrain such as islands, archipelagos, straits, or shorelines and where area denial methods are present by an adversary. For mines in the surf zone and on the beach, the Joint Direct Attack Munition (JDAM) Assault Breaching System (GBU-61) is the only capability currently available for breaching mines and obstacles from the 10-foot depth contour to the beach exit.

One embodiment presented in this breaching system seeks to further previous technology as disclosed by Scarzello et al. This technology was developed as a capability requirement and used by The United States of America as represented by the Secretary of the Navy. That technology incorporates electromagnetic waves to establish a navigational grid by identifying floating, proud and undersea mines.

Solutions to be used as capabilities were reviewed for development by the National Science Foundation, John Hopkins University Applied Physics Laboratory, Advanced Explosive Ordnance Disposal Robotic System Increment 3, sponsor support contractors, Command Users, service sponsors, Naval Surface Warfare Centers Indian Head Explosives Ordnance Disposal Technology, ONR FP and M2 SMEs, DASD Emerging Capabilities Office in 2014-15 for current R&D focus areas and technology transition in order to fulfill Capability Gaps. As the Document Sponsor, IHEODTD is the organization to submit capability requirement documents and as the Solution Sponsors for successor documents. Single Manager responsibility exists where IHEODTD is designated to develop and field EOD related capability solutions and NEMW technology development responsibility rests with NAVSEA Dahlgren. This responsibility also fulfills Integrated Priority List requirements to prioritize Joint Service, functional lines and define shortfalls. Here, through adoption of this modular technology, the emergent technologies may be integrated to improve the overall capability of EOD warfighters and further protecting dismounted warfighters and civilians alike.

Operation speed and maneuvering including tight turning is afforded by the fact of equal wheel base to track width yielding nearly a zero turning radius. Any of the customary control methods are possible, including remote or wired joystick as leader-follower arrangement, by satellite, or run automatically with sensors combined with artificial intelligence software for avoiding obstructions and on memory-learned pathways for routine path mine checking.

Common current field practice operating unmanned vehicle involves avoiding and maneuvering around debris and small stones and rocks, which lay in a path between two points of the objective route. A deflector or barrier that may have multiple panel segments may be mounted with struts to allow for shockwave absorption. The barrier or deflector may be counterweighted and have further barrier functions for Force Protection from fragmentation. Optional sensors read incoming path profile and controls deflector and the probe assembly. The feedback loop created maintains a telemetry system for all ground sensors. Procedure also may include sidestepping mine and installing a flag for the affected area. The assembly may retract for protection during deactivation attempts or detonation.

In another embodiment, a remote retractable robotic arm is deployed to execute disarming when desired. The arm may have an end Effector with specialized configuration for rapid neutralization procedures for forensic evidence requirements. An air tube routed to the deflector or barrier base from the gas ejection system is a tool for air blasting sand to uncover mines. UXO threats are in the millions being mostly AP landmines that have the potential to be deactivated. In order to provide the robotic means for neutralization, the proposed Primary End-Effector and Manipulator is proposed. The CM Suite fits ADD, ICD and MPS requirements optimizing autonomous behavior performance and neutralization capability. The majority of AP Mines have a discrete number of steps to deactivate with kinematic rotation and range workspace requirements. The wrist feature shall use an extendable anchor strut mounted in and on the wrist connector. Modified retractable conformal finger ends shall be suited for terrain manipulation, mechanical disassembly functions to rake, shovel, brush, unclip and unscrew at the closest of trigger positions during neutralization efforts from a deployed robotic arm. For this procedure the need of two robotic arms being controlled in a limited amount of space is optimized. Below the chassis, transponders and a small anti-mine countermeasure system may be located for miniature remote controlled torpedo use with rack.

For normal conditions, the robot or vehicle travels for a new mine countermeasure for field use providing simultaneous lane detection and fragmentation protection system. A specifically arranged configuration and assembly for replicating foot motion and pressure with a compound articulating mechanism is employed. A controlled pressure may be between (0 to 30 psi) for a vertical reciprocating system for mine activation is utilized for positive soil contact and pressure to be delivered across the width of the vehicle's pathway. A barrier curtain, billows, plate or canopy system for fragmentation protection is utilized. A secondary high voltage electric discharge or disruptor system may be used for triggering.

The various elements that work together or individually in turn function together in an accumulating efficient manner reducing battery load requirements to operate the vehicle mechanical functions and computer systems. The components and assemblies are described as a prestage gas ejection detector, probe head boot, a strut probe assembly to impart a minimum of downward force, a timed pressure manifold for strut(s) and a strut energy dissipating canopy with chute. As the prevention of mine accidents is paramount, longer operating times for the mine defeat system are preferred increasing daily service time. Each element described contributes to lowering energy demand and/or vehicle stability.

As the vehicle has its vertical probe assembly attached to the vehicle for clearing mines from a pathway, a strut can be used to provide a downward force. This force is used to drive the reciprocating probe which has the added potential of drawing dynamic energy from its' speed in impacting the ground. A constant pressure control is introduced in a timed manner through the use of the pressure manifold and relay to achieve the lower reaction force when the probe is not in extension mode for each cycle. The pressure manifold and relay is located in an area away from the containment space. It combines the signaling of the probe head cycle for probe extension with the opening and closing of volume space in the strut(s). The function of controlled volume is provided with the primary feature of strut rod movement. Additional mine detectors will enhance the triggering to dissipation process. The ability of the machine's probing units to move along will be improved by utilizing carbon fiber or other blast resistant material wrapped around the base of the probe or shoe acting as a flexible boot. A positioning of a mine detector will allow for prestage gas ejection. The probe head assembly may utilize a control ball knuckle for limited directional range of motion.

The placement prevention of mines is simultaneously done in an active format through constant motion and personnel verification using a 360-degree turret to create safe-zones, which is a primary focus for all countries. In each typical village, small areas shall benefit, primarily villages and village connecting trails. Rotation of the camera of 45 degrees to left and right provides 360 degree of coverage with the turret operational. The majority of mines are delivered and set in place by individuals or groups who reside outside the community or village at risk. As an advantage in the self-contained and efficient capabilities, the vehicle is able to continuously perform motion detection and identification checking, through this simple but new effective data gathering technique.

### DRAWINGS—FIGURES

FIG. 1 is a perspective schematic view of the Hybrid Chassis Breaching System according to the preferred embodiment of the invention.

FIG. 2 is an interior schematic section showing the chassis-body-drive arrangement.

FIG. 3 is a side elevation view depicting a mine countermeasure system.

FIG. 4 is a rear perspective view of the robot.

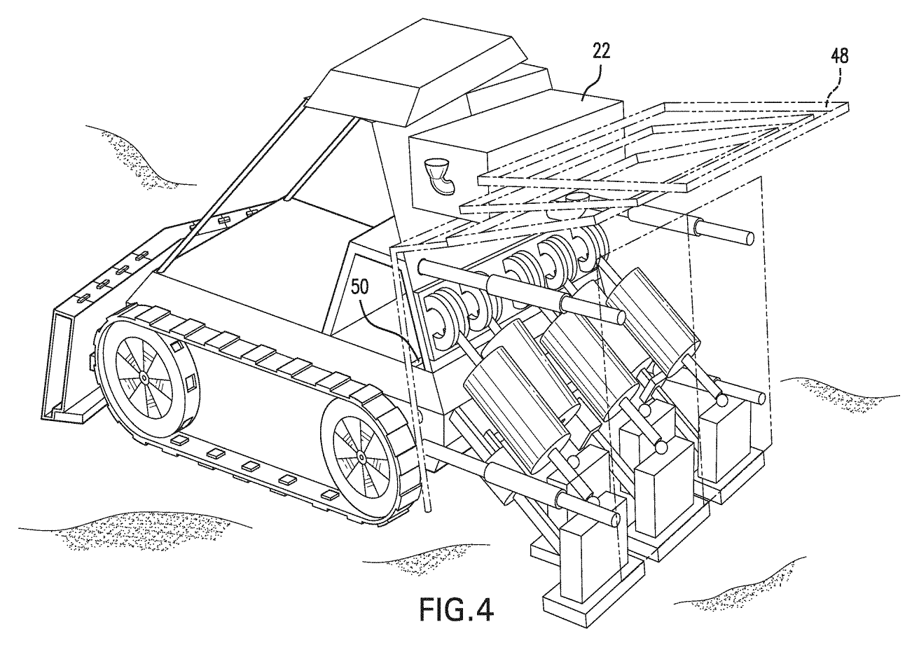

FIG. 5 is a front perspective view of the robot with modular countermeasure system.

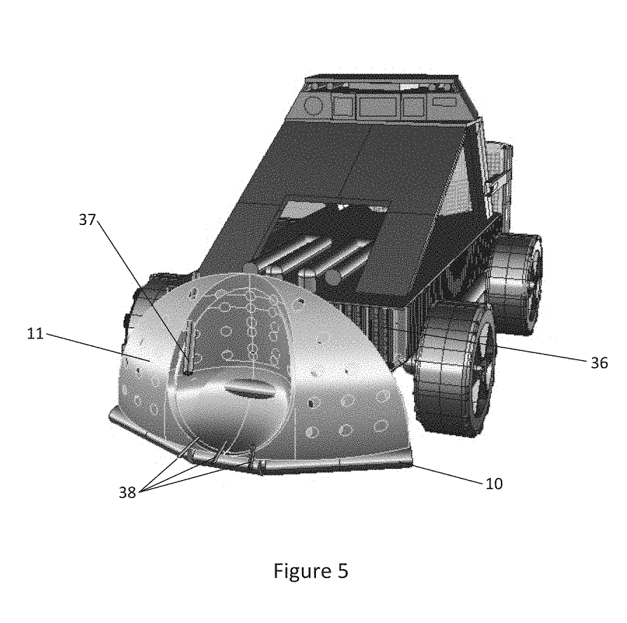

FIG. 6 is a partially exposed rear view.

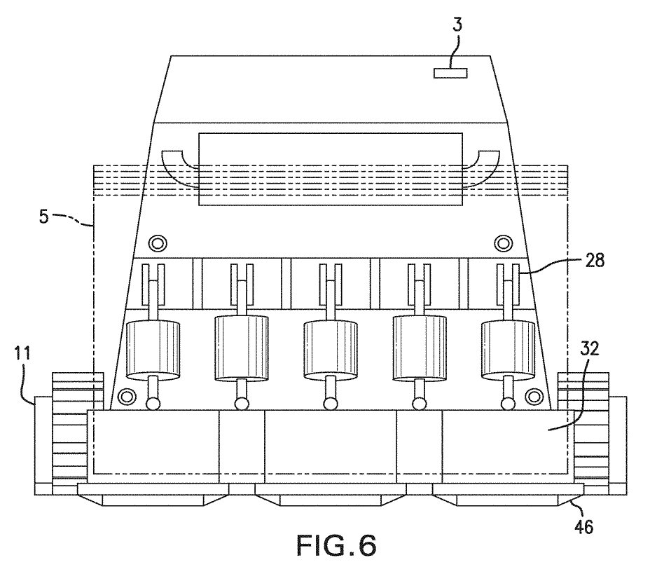

FIG. 7 is a plan of the Green Energy Thermal Electric Generator/Gas Reactor Module.

FIG. 8 depicts one alternative for a gas ejection system.

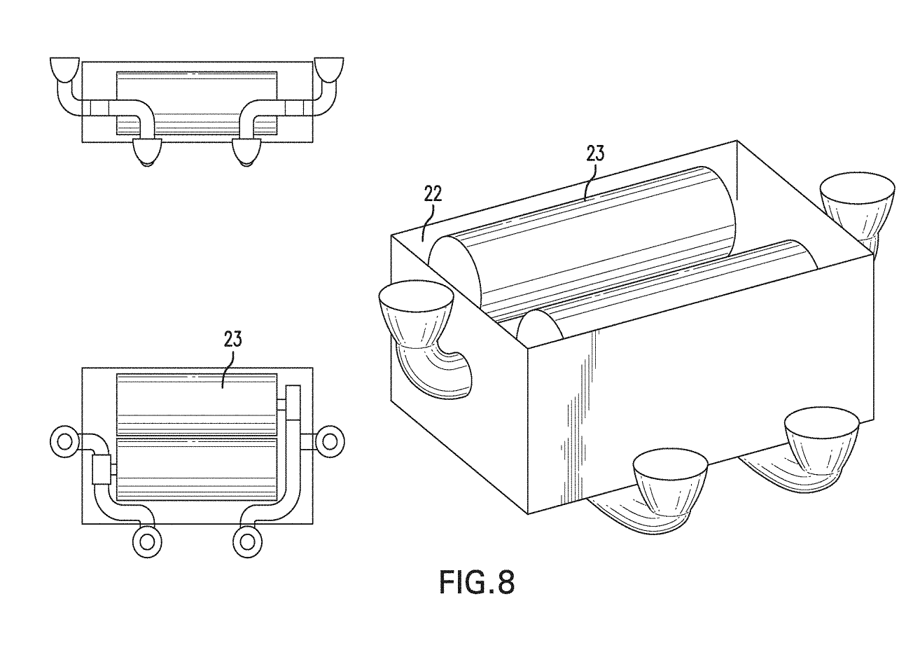

FIG. 9 is a plan schematic view of the mat system.

FIG. 10 depicts an isometric view of the Fragmentation Protection Device.

FIG. 11 depicts the integrated shutter, cartridge cell and gas reactor assembly.

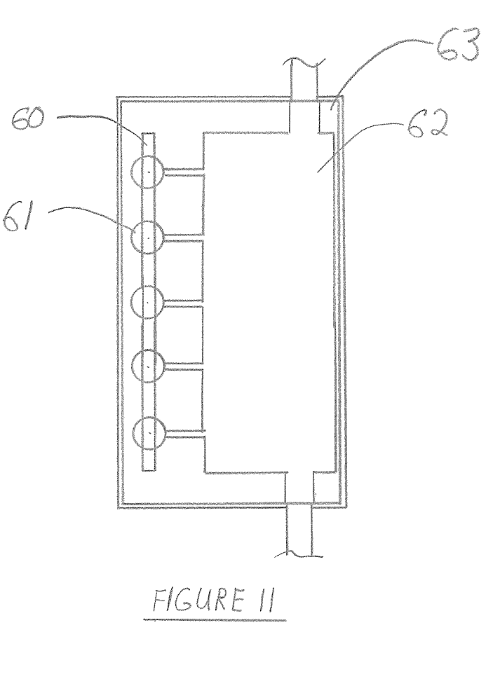

### DRAWINGS—REFERENCE NUMERALS

1 turret
2 wheel assemblies
3 camera
4 slide black Box
5 modular Force Protection barrier
6 robotic arms
7 vertical reciprocating system
8 concealed robotic arm system
9 self leveling system
10 detector
11 fragmentation barrier-deflector
12 thermal electric chips
13 micro-turbines
14 energy conversion housing
15 solar power system
16 wheels
17 chassis-body
18 DC motors
19 batteries
20 turret
21 chassis-body
22 gas tank system
23 gas vessels and nozzles
24 canopy
25 curtain billows
26 rear blast plate-canopy
27 mounting rod
28 hinged sliding spline control bracket
29 strut-cartridge
30 foil lever
31 control volume solenoid valve
32 vertical reciprocating power-head
33 axial actuator
34 line charge
35 bevel edge
36 sandwich device
37 disruptor
38 high voltage electric discharge
39 encased charges
40 duct energy deflector
41 supporting member
42 flexible edge connection
43 pressure activation lines
44 pressure system
45 apron
46 probe boot
47 probe shoe mine detector
48 opening
49 gas reactor expansion cell
50 chute
51 capillary channels
52 evaporator
53 condenser
56 opening
57 device
60 shutters
61 magnification lens
62 heating chamber
63 gas reactor
64 inflatable tire segment
65 segmental wheel cleat
66 internal wheel vane
67 wheel rim
68 crawler drive leg
69 mat units
70 float system
71 transponders
72 countercharges
73 stiffening beam elements

### DETAILED DESCRIPTION OF EMBODIMENTS

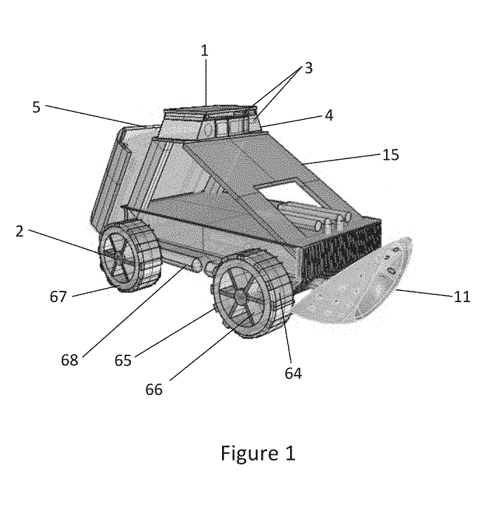

As shown in FIG. 1, the HCBS is a robot that is sized, configured and reprogrammable to perform a variety of different mine detection and neutralization tasks to create safe paths for people travelling on foot and when moving through and coming out of the water. The primary chassis 17 has buoyancy capability with calculated Metacenter for stability. The first apparatus 11 is the debris deflector and barrier. A detector and triggering device may be configured onto the chassis through components or recoiling struts at any position for defeating mines. Electromagnetic or high voltage electric discharge methods may be employed to trigger IED/Mines at a safe distance. The robot has a control system including actuators and sensors positioned to remotely or autonomously provide mine defeat procedures. This robot provides an operational method which reduces stop and delay and allows for Force Protection from IED/Mine fragmentation.

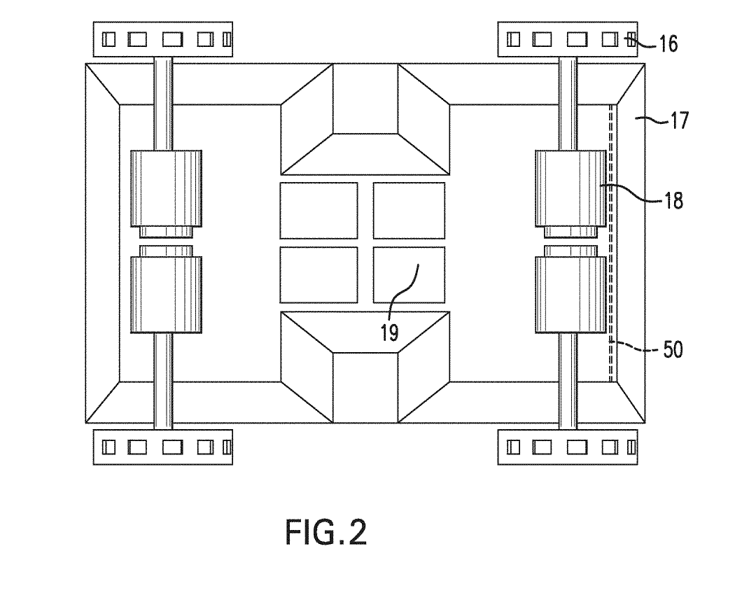

Above the chassis is a structural frame, which acts to support the green energy module 14 and is secured with shock isolation and quick release mounting for servicing. This recharging module contains a Thermoelectric Generator Gas Reactor (TGGR) solar panel 14 with bullet resistant and magnification surface 13. From FIG. 2, a vertical interior section view looking down with the four drive wheels 16 can be found. Where the surrounding terrain requires better traction, the vehicle has the ability of use of additional flexible tracks to be field installed. Inside the chassis 17 are normal DC drive motors 18, current controller means and the battery set 19. End of crawler leg wheel motors for traction drive may be used. The top of the chassis provides space for an optional bio-fuel power-plant that is not necessary but would provide added daily service hours that may be of advantage. In front of the chassis is an optical camera 12 for close in monitoring of operation of robotic arms having at least three degrees of freedom with rotary joints that may be stored in a recessed chamber 8.

Many types of Green energy sources are possible for energy conversion for power and recharging in the industry's current technology. The differentiating detail noted in the following method is the aspect of energy being created by both solar and gas means for recharging purposes. The system is not limited to energy generation by heat reclamation from internal processes. The following embodiments of green energy use are described in sufficient detail to enable those skilled in the art to practice the invention. One or more multi-stage systems may be used in parallel are contained in a protective housing that is field replaceable as a unit for maintenance or from damage with quick release and connect frame attachments and energy cables. The degree of sustainability is high when using recycled densified pellets as an energy source while maintaining reliability of power delivery with a combined conventional engine for recharging and power.

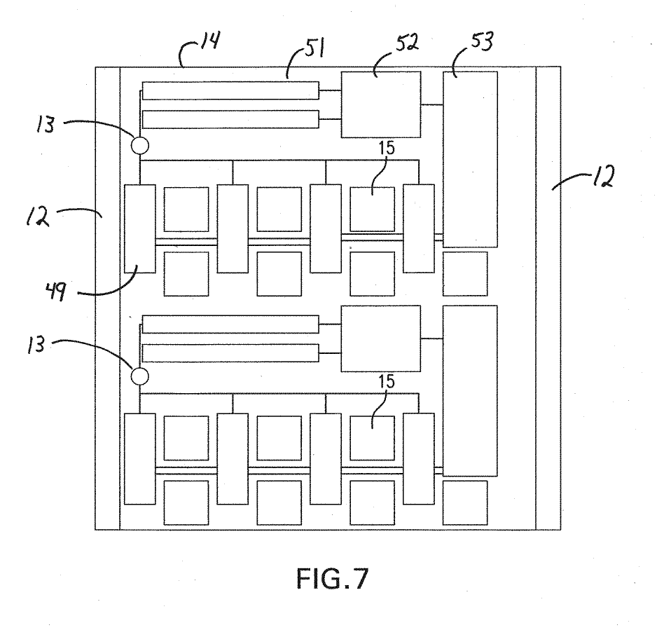

The proposed system, FIG. 7, has the following process to convert both thermal and light energy using sunlight and gas. Contained in a protective container are several elements which transform energy. The simplest form is the photovoltaic cells 15 which may have a magnification prism or lens for intensification. These are distributed in the container around all other elements which are of irregular geometry. They provide immediate voltage from sunlight exposure.

Another electrical generating method contained is a liquid to gas vapor system 63 wherein the vaporized fluid is channeled through a turbine generator 13. The time controlled heating of fluid to gaseous phase is accomplished by a set of shutters 60. A magnification lens 61 focuses sunlight to vaporize the working fluid. One way pressure valves control the flow of fluid in the system from the fluid chamber to the heating chamber 62 through the turbine to the vapor chamber for reliquification.

The working fluid may be methanol, ammonia or acetone although other fluids may be used. The vapor is reliquified in the heat transfer device for use in the system again. The heat dissipation device may include elements such as fins or rods that provide large surface for providing spreading and dissipating heat including volume expansion devices. Other effective means such as capillary channels 51 may be used to improve efficiency for vapor reliquification.

An effective manner of phase change rate is to provide a permeable membrane to make an efficient mass transfer process. The process makes use of capillary transport force acting on the interface of the porous material thereby increasing the rate of vapor venting and removal of corresponding heat flux. A classical evaporator 52 and condenser 53 system may also provide for to maximize the reliquification process.

An additional method for turbine generated energy is included by the introduction of either pure gas such as propane by pressure cylinder vessels or concentrated solid pellets with known dissociation kinetics can create a reaction cell for daily use. The pellets may be of any size which maximizes the liquid gas reaction. The pellet would then combine with an adequate solution and/or catalyst to facilitate the gas expansion phase in the cell. A series of cells forming a cartridge like insert is possible for cell by cell depletion having the individual cells connected into a parallel manifold pipe. Each of the cells having a pressure sensitive orifice disk which ruptures at a predetermined pressure or temperature. Each cell being activated by automated timed sunlight shutters with magnifier lens. Upon depletion of the cells gas concentration, the sunlight shutter is directed towards the next full pellet cell. This pressurized gas then passes through the turbine for additional electric charge. In line flow restrictors control any overpressure. These pure gas methods are utilized by providing a by-pass tube allowing for venting externally away from the evaporator condenser process elements. The total package delivers an effective optimized combined multi-process for exploiting green energy. The combined Thermoelectric Generator 12/Gas Reactor 63 charging system will allow for longer daily use of the system.

In addition to the previous discussed energy methods for conversion. The current state of the art allows for other various methods of conversion. Additional capabilities may be achieved by the use of hydrogen cell power conversion charging stations. These stations can greatly extend the network and range of coverage for the individual containment robots. Each station would allow for overnight charging which would make the daily duty rating increase. The typical station can be a standalone protected structure for the power generator and containment robot. The primary low demand and low cost continuous refueling requirements would be vessels of water, hydrogen and routine maintenance.

The supporting frame is also a shock cage, which has internally telescoping cylinders for force dampening. Above the shock cage is the turret 1 which is able to swivel horizontally 355 degrees, tilt and pan. The external shell of the chassis may have sandwich device assemblies. These shell assembles may form a barrier system which is connected to the internal shock cage having energy dissipating struts.

The turret 1 contains two optical cameras 3, one forward that creates 3D vision when synchronized with the lower chassis camera 12 and one to the rear for real time monitoring and motion detection and verification. Motion to identity security containment and control is accomplished. This significantly protects those registered in the safe zones and residing in the secured areas with personnel and civilians using IC Card verification. A simultaneous process of motion detection with verification of safe zone identification signals is read by computer hardware which may be located in the black box 4.

Establishing this security process in any area of mine placement activity defends against further mines from being placed. The onboard capacity contains the logistics that would assemble information into a centralized database for use with and for field personnel to access this remote mobile vehicle. Information integration and analysis becomes real time. Verifying ID, document check, and controlling a single identification is extremely crucial as the ease of multiple identities is wide spread. Selective biometric applications involving identification cards containing radio frequency capacity technology for control movement in secured zones. Modernization programs rely on individual identification cards being required to carry. The following soft approach abilities for data gathering are presented for use in an efficient integrated fashion at low cost. Each optical camera included may be in a self-contained blast resistant removable black-box 4, one on each side of the turret, which contain operational control and communications integrated circuits and hardware. The turret is also supported from the rear by the back wall, hinged at the top, for additional dampening benefit.

In another embodiment for allowing operation in the water, the turret needs to maintain an above water position for maintaining camera video feed and situational awareness. The time at which the platform is underway in water is maintained through the overall chassis and shell righting moment with metacentric height and a deployed buoyancy device around the turret allows the robot to achieve the condition of surface movement underway with only the turret visible at the surface to be established. The turret may have a second level optics configuration where the optics may rotate and focus by turning from the turret's primary direction. The turret may morph into an instant second location for safety from projectiles by the use of hydraulic cylinders. Turret or shell may have a shape changing shell by extending a sidewall height by actuators to modify the signature or to provide an optimized antenna shape. Temperature and density of sidewalls may be varied by methods known in the art.

In another embodiment coming out of the water during amphibious landings requires an SUV be able to move and maneuver in the very shallow water (VSW) and tidal zone where various wave conditions exist as well as cross currents. This condition causes various platform unmanageability and instability problems which require special platform thrust capabilities in order to maintain control to make landing on the beach. The known use of thru-hull thrust drive systems may easily be integrated into a chassis, vessel and shell forming a Hybrid Chassis Breaching System (HCBS). In addition to this the change in buoyancy while coming out of the water has a very high possibility of overturning the platform in transition from floating to traction drive. This synergy of operations can be optimized through the use of segmentally inflatable tire sections outside of the rime and between cleats on the rim. Tires may be conventional tires inflated all the time. However, compact design is required in order to maneuver on land to establish traction and perform turning tasks. When each wheel is inflated the buoyancy of the individual wheel assembly may be increased by several-fold allowing for an additional method of flotation at wider points for platform stability. Wheel drive assemblies may be supported by shock absorbing telescopic crawler legs. Each leg pivots and is swing controlled by actuators up or down through a curvilinear path. Any strut, gear mechanism or method known to the art may be used to pivot each leg. In addition to the wheel assembly having the capability to change volume, the combination of providing an internal angular vane design may be integrated into each wheel between hub and rim. The wheel vane shape and pitch is configured to move water through the wheel. The purpose of this design is to function similar to a propeller for lateral thrust while moving through waves, which may be breaking, causing turbulence within coastal landing zones (CLZs) with crosscurrents. This thrust action provides yaw control during forward motion or while maintaining position. This lateral thrust shall improve the possibility of the HCBS to make landing in difficult CLZs and while conducting detection and breaching operations.

In another embodiment the operation for landing of personnel and equipment needs to have reliable mine search methods for detecting, clearing and creating lanes. The area of water which meets the shoreline may have floating or underwater laid mines. Hydrographic reconnaissance of an area of water may be possible to determine depths, beach gradients, the nature of the bottom, and the location of coral reefs, rocks, shoals, and man-made obstacles. For any of these conditions, the approach in water by surface vehicles must have a technology which is able to overcome these obstacles. The HCBS includes a method of deploying any series of modules for creating lanes within the VSW and CLZs. This system is air and ocean deployable operating in sea states where the wave height is not severe and amphibious landings are preferred to be grounded within the wave period. As such the system design takes into account those dynamic tidal forces. In order for the system to be effective the system must have system, design and performance characteristics that are reliable for various bottom conditions as well. To achieve this along with the wave action and crosscurrents, the individual modules have the cross-section design which synergistically reacts to the changing flow of surrounding water in a primary direction. As the nature of an amphibious landing approach is to use the best path to shore, this is generally controlled by the local wave action.

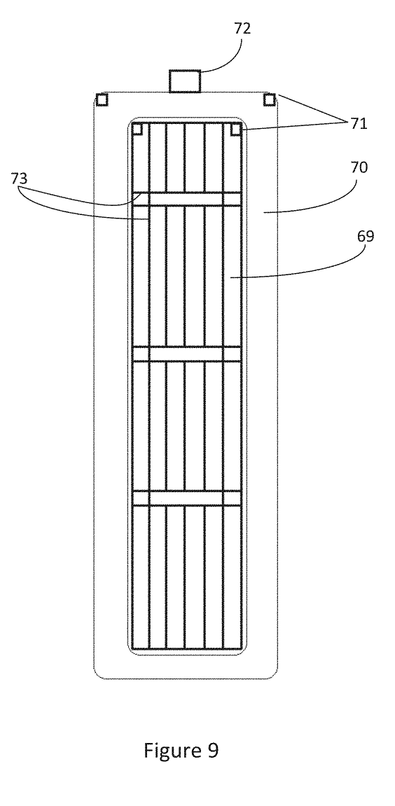

The mission module, Ballistic Composite Array Mat (BCAM), see FIG. 9, is either towed, self-propelled or driven into the offshore position where landing is planned. The module may have a length which is both unfolding and attachable from end to end forming a longer or side to side forming a wider series of units. The BCAM module FIG. 9 may be pushed along in any tactical way with a float system to bridge over underwater and floating mines with transponders and GPS for telemetry, deploy countercharges and set coordinates for JDAM where mines are detected. For locating and detecting of anomalies any method known in the art including transponders with specific frequencies for establishing high order telemetry of bottom and floating threats with GPS tracking may be utilized to allow for an underway recording of bottom conditions. This system of detection may be integrated with further offshore sonar and cable methods as described by Scarzello and further establish higher probability of detection for use of mine countermeasures. The HCBS chassis and mat may be fitted with transponders to transmit signals for further mine locating and countermeasure deployment for mine neutralization with the unmanned underwater system as described by Scarzello having the system where a computer-controlled transmitter unit having a waveform generator and amplifier, transmits signals to each antenna. This allows the HCBS to navigate from the surface vessel or other deployment method through the VSW to the beach. When closing into the preferred position, the assembly is remotely deflated and sets into the preferred position creating safe lanes for travel simultaneously providing fragmentation protection and shockwave absorption.

Each Module has multiple mat units interconnected and may have a unit area design which follows the primary wave action direction. This is accomplished by having a pattern of openings where water is able to pass through with internal passage deflected with internally aligned ducts in the desired direction. The result of the pounding waves and local current is to have an inertial effect on the mats direction and to set into place at and into the top level of sand sea bottom. The pattern of duct's direction may be established in a particular arrangement to have a drift effect to counter the landing site's cross-current conditions. The module may have any number of blast resistant mat units forming an array in any shape connected at the edges. The edge connection may include flexible carbon fiber woven fabrics that are epoxy layered into and between the blast resistant units. Each unit may be one or more layers to achieve the desired effects and performance. The sides of each shape may be connected to a stiffening element or beam for the purposes of strengthening the overall assembly and to bridge over encountered man-made, natural obstacles and those bottom conditions that exist which hinder personnel and vehicles coming out of the water.

In another embodiment, a deflector or barrier 11 as illustrated in FIG. 1. Each barrier panel section is slightly angled from the vertical and from the path centerline forward, so as to give a reaction downward from the impact force from shockwaves or move obstacles. Each panel segment is connected by a simple hinge-pin mounted at mid-panel height. The panels are overlapped so as to create uniform coverage while sloping up or down on the path's surface. From the existing ground surface, tines may be placed which act to catch and clear individual stones larger than ¾ inch round in size. The deflector or barrier assembly may be fitted with mine detectors, which produce very little downward force when not mechanically controlled with a height sensor controlled system. The assembly is supported by two side arms or struts to maintain a controlled forward projected distance from the chassis, allow for upward rotation, retractability and dissipation. Immediately behind or below the deflector or barrier assembly are detection devices 9. A canopy or blastplate may be used to contain fragmentation and be remotely deployed by any method known in the art which may be expandable and use tension bands for controlled release. The deflector or barrier assemblies may have a secondary canopy systems mounted over the top and sides. At the base of the deflector or barrier assembly, a spade may be connected to ground forces from the shockwave. This component acts as a work-energy device is used as a spike or spade and is released by an eccentric lever linked at the underside of the assembly to effect drag into the underlying ground surface upon the shockwave impacting the barrier system.

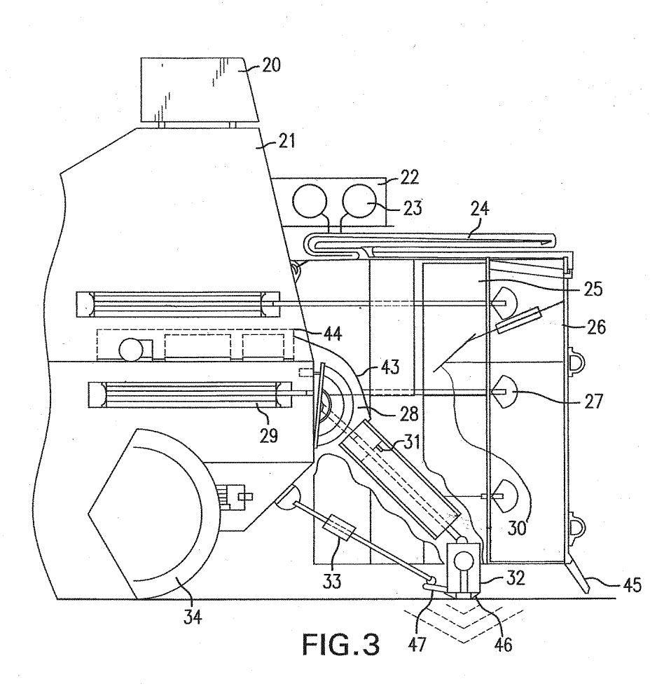

The primary countermeasure system is illustrated in FIG. 1 and is a new modular barrier assembly or unique apparatus for simultaneous detecting, triggering, fragmentation protection and shockwave pressure from IED/Mines. The features are shown at the front and rear of the vehicle. The vehicle may work in reverse direction where hazards are extremely high to maximize containment advantages. At the rear of the vehicle a vertical reciprocating system is shown 7, followed by a containment plate 5 and covered by a canopy deployment system 2. From FIG. 3, the rear of the vehicle can be seen. At the ground surface, a reciprocating foot 32 assembly and/or high voltage triggering system may be employed to clear mines for a determined width, which applies the appropriate pressure based upon the range of in-situ soil shear strength. The advantageous feature being created is that the reciprocating system assembly self-propels itself in two distinct ways. First, the individual line of action is inclined a few degrees from vertical, as a foot does. Secondly, a lower control arm with an axial actuator, may be used to control the advance throughout the timed cycle of operation. Each foot has a power head that provides a means of rotation and a controlled variable positive soil displacement, which acts to alter soil at or below surface and accomplish the mine trigger objective by simulating foot pressure and motion. Accomplishing triggering, ignition or downward force may be by any means known in the art which may include, but not limited to, plasma, rollers and electric inductance or electromagnetic means.

The modular, preloaded feet with reciprocating probes are signaled to cycle in a timed fashion for maximizing the net downward force. Downward force for each assembly is provided by a preloaded pressurized strut 30, supported by a vertical spline control bracket 28, which limits horizontal range. The configuration of this apparatus is designed to remain in a horizontal orientation for existing ground undulations of plus or minus three inches and maintain continual ground contact.

From FIG. 3, an improved embodiment may be utilized in the form of a dissipating strut and probe assembly for the clearing of mines from pathways. To ultimately reduce the drag for motion and improve vehicle stability, a plurality of elements are utilized to work together or can be used separately. In this embodiment for said dissipating struts 30, an improved strut performance can be realized. Each strut utilizes a control volume for manipulating the amount of gas/fluid to be displaced during extension and compression. While the reciprocating function of the probes are under way, the control of downward force is controlled in a cycled manner from a lower pressure value to a timed and synchronized higher value. Both values are able to be controlled by the predetermined size of vessel and the internal rate of displacement from the rod extending or compressing when entering and exiting the strut cylinder. The cycling operation is activated by the use of an internal solenoid valve 31 mounted into the control volume wall which when activated opens and closes the additional internal control volume within the strut chamber. The cycling timing of the solenoid valves is accomplished by the computer or a separate controller which sequences the strut high pressure level with the probe extension.

In another embodiment, a pressure system 44 with accumulator and manifold has pressure activation lines 43 connecting from the dissipating struts to a timed pressure manifold and relay system which combine electrical signals and line energy to open and close manifold valve ports, extend each probe assemblies, being branched and controlled separately to sufficiently cycle the probe extension with high strut pressure in a sequential manner. A controller sends signals to the relay of the manifold and to activate the probes together in a cycled and sequential manner of operation. Activation lines may be energized in an air, electrical and/or hydraulic manner. A combination of the two methods may be utilized for maintaining redundancy and improving reliability.

The strut controls the amount of downward force on the probe head. The overall assembly may be raised or lowered by rotation through a hinge located on the spline bracket and may be by hydraulic means. The control of these assemblies and components are controlled by the computer and actuators to allow for the robot to articulate any element remotely or autonomously. The spline plate brackets 29 may be used independently for each strut and probe assembly or mounted on a single plate. The movable plates and their positions have a maximum load rating in the extended down operation position that freely release upon detonations by means of a breakaway link, load failure device or other load limiting mechanism that may incorporate an axial piston or other suitably fashioned device to relieve over-pressure. The primary combined feature is a piston lowering the hinged plate and upon a specified overload pressure, the plate rotates closed and simultaneously slides up for a short distance. This combined mechanism and load path creates a deadening effect for the short duration of the pressure wave.

As an alternative, another possible arrangement for the probe head connection and to maintain vertical orientation of the probe action is through the use of a modified connection, a spherically seated control knuckle providing a limited range of rotation. This may allow for more extended use in the field should damage occur. In this embodiment, the base of the strut rod is connected in a vertical plane hinged manner, with a slight degree of out-of-plane deflection possible, to follow the existing ground profile. One embodiment of the connection is to use a control knuckle which has a ball or spherical shape connecting to a similar shaped receiving yoke type socket mounted vertically into the top or side of the probe head surface. The top of either type ball shape used is further guided and controlled in a single vertical plane direction with limited angular range of motion in both rotational directions, accomplished by having a rectangular opening in the top of the socket face and attached to the probe head. The load exerted through such an assembly causes forces to be transmitted normal to the plane, perpendicular to that mounted plane which achieves a desired inherent self-balancing downward force. Said knuckle design may allow for single connection to probe head should damage occur to other links. This forged spindle ball joint has a controlled seat.

The strut assembly may have a critical break-joint design feature to have a planned strut loss to enhance vehicle stability. The break joint may consist of a reduced section of the strut rod or an equivalent means for high load failure. A plurality of mounted dissipating strut assemblies is possible. Each strut assembly may have a pressure limit valve or blow-off for relief of pressure in or on the strut housing for relief activation during the mine event.

To further absorb energy and minimize energy effects, the configuration of certain absorption components and elements may be introduced and the strut probe head assembly. A unique arrangement of benefit may be utilized. The effect of concentrating a calculated percentage of force through the strut would be directed into the recoil bore assembly. The application of recoil and recuperator technology may be used to dissipate energy and solve chassis stability to overturning. Additionally, a portion of the pressure wave will be redirected. The probe head or other mechanisms may be configured so as to have a slightly cupped face facing towards the imminent blast point. The probe head face plate may have a V-shape or other shape to direct forces. To increase the pressure rise time, a layer of viscous material may be added onto the face plate of the triggering mechanism.

The strut assembly having a central rod becomes driven through the strut housing. The strut rod and housing assembly may be conventionally axial in action or be curvilinear and may have a pivot connection. As a method to slow the instantaneous effect of the blast, the strut rod may be made longer to achieve a better time of dampening forces. Absorption of energy is treated as recoil except the gas or fluid orifice pressures would be containing the rod force at the end of its travel acting as a shock isolator. The first rod distance traveled acting as a common shock absorber and after a predetermined overpressure an internal valve would open and the full range of rod travel into a secondary gas or fluid pressure chamber. Any series of orifices, secondary cylinder walls for relief volume may be used to increase the duration of recoil impulse and absorb energy and momentum.

Any assembly, component or barrier may have a mounted or body formed muzzle for replaceable reaction charges. The counter charges may use any type of propellant such as M7. The charge may be initiated by a direct connection or signal from the probe of the head assembly to the charge in the breech upon triggering a mine. The reaction of these charges may be of various sizes and will be directed so as to counteract the upward force from the mine onto the machine. Establishing the exact position and direction for this feature will be accomplished by those skilled in the art.

The probe head contains the means for providing a reciprocating probe element. Additional mine detectors will enhance the triggering to dissipation process with an advance signal to start. This may be created by positioning the mine detector sensor on or near to the probe head. In operation, as the machine is in motion, a mine detected or located near to the probe head mine detector sensor 47 sends a feedback loop signal for gas ejection to start a few moments before the probe detonates the mine.

Any type mine detector known to exist and in the art may be attached and located in any position on the vehicle or barrier systems which would assist in the determination of the specific location of below or above ground mines. Mine detectors are commonly located as close to the ground as practicable. Mine detectors may be attached to the robotic arms for side scan use. Additional sonar and underwater cameras may be suitably arranged through the bottom of the chassis for underwater mine counter-measure procedures. Guide roller surfaces may be included in the induction field circuit. Mine detectors may be added at the base of the deflector or barrier segments in a variety of connection means such as attachment to the individual deflector segments and probe head shoes through the use of small connection tables, brackets and shelves as well as a more ruggedized, potentially molded integral assembly, whereby the individual parts, such as but not limited to the deflector plate segments, barriers, sensors or probe head shoes form an integral, composite or a detachable-attachable assembly. The individual mine detector sensors can be hinged with springs to allow further improved ground clearances, pitch and angle of incidence and be attached by any practicable means known in the art including as a slide or snap on component.

The combined elements of probe head, probe head shoe, probe and prestage detector or parts thereof may be covered for ease of sliding motion over the ground as well as protection, by a flexible carbon fiber or blast resistant material acting as a boot 46 or jacket element for additional guarding against sand and foreign elements. The material of the boot shall be flexible to allow for the repeated probe extension cycles.

A mine detector may be mounted on the front of the robot or vehicle locates mines. As these mines are located, a signal is sent through the feedback loop and are recorded for relative location which also may include positioning by satellite in the on-board computer located in the blackbox. The location of the vehicle is converted into data by two methods. The first is by common GPS positioning. The second is by surveyed range locators that are read by sensors on the vehicle for grid locating and stored on the computer. Other means for determining and storing distance travelled and grid location, along with user remote control exist to those skilled in the art. The blackbox protects these remote controlled, automatic and guidance control features for operation. The machine having possession of this information, along with its inherent motion tracking, calculates by means of computer when the mine shall approach the rear probe assembly with mine detector.

As the machine is working its' way forward or backwards and nears the located mine, a gas ejection or propellant system is activated at a predetermined time or manually before detonation. Detonation may be accomplished high voltage methods or by any of the known methods available known to those skilled in the art.

In scenarios where neutralization is possible, a simple end effector with wrist strut may be employed requiring less space to deactivate IED/Mines. The majority of UXO threats are in the millions being AP landmines that have the potential to be deactivated. In order to provide the robotic means for neutralization, the proposed Primary End-Effector and Manipulator is proposed. This robotic arm and effector suite fits AEODRS ADD, ICD and MPS requirements optimizing autonomous behavior performance and neutralization capability. The majority of AP Mines have a discrete number of steps to deactivate with kinematic rotation and range workspace requirements. The feature shall use an extendable anchor strut mounted in and on the wrist connector. Modified retractable conformal finger ends shall be suited for terrain manipulation, mechanical disassembly functions to rake, shovel, brush, unclip and unscrew at the closest of trigger positions during neutralization efforts from a deployed robotic arm origin possibly recessed or below UGVs. This procedure eliminates the need of two robotic arms being controlled in a limited amount of space.

When the mine detector encounters a mine, an electrical signal is sent to the computer for creating a grid location using known range locators. Satellite positioning data for longitude, latitude and elevation is recorded in the computer. The gas ejection system 23 is started for the release of gas. The gas may be stored in vessels under high pressure in a protective enclosure mounted to the vehicle. The mine detector sensor signals the computer via the feedback loop and activates the solenoid valves or other means of automated valve opening actuation being electronically controlled by the detector sensors or the computer located in the blackbox. The overall operation of the machine is synchronized by the onboard computer using integrated circuits which may be remotely operated. Any means of directing gas or propellant common to the art may be used, openings, ports or nozzles to control and direct the flow of gas upward, such as a plurality of ports, outlets, tubes or nozzles which effectively direct the gas jet in the directions desired.

The Hybrid Chassis Breaching System provides components enhance the performance and stability while reducing maintenance time for longer durations in-service. Upward directed gas or countercharges shall have balancing vertical force and/or horizontal force to either assist to propel in the forward or rearward direction. Control of gas ejection or countercharges in any direction is controlled by the computer or remotely for thrust and exhaust velocity or may also be pressure sensitive for simultaneous reactions. As an example of control of gas, a series of electronically controlled automated valves controlling the gas in each direction can synchronize the control of gas in the desired directions. Other means of gas ejection exist in the art which create sufficient gas ejection and downward force to assist in the counterbalancing of the machine or vehicle before, during and after detonations for improving vehicle stability.

Any of the elements of probe head, probe head shoe, probe and prestage detectors or parts thereof may be covered for ease of sliding motion over the ground as well as protection, by a flexible carbon fiber or blast resistant material acting as a boot 46 or jacket element for additional guarding against sand and foreign elements. The material of the boot shall be flexible to allow for the repeated probe extension cycles.

In order to improve planar stability, one or more gyroscopes may be employed. A lightweight disk of sufficient weight may be mounted and spun on the structure so as to resist toppling. The axes of rotation shall be set so as to contribute to maintain controlled lift along with roll and topple forces from the event. The action of starting the gyro would commence before and reach full speed before the event. Each Gyro may be supported with isolators of viscoelastic materials or other materials known in the art. The skilled in the art will adjust the global attitude of each gyro assembly to maximize the affect for vehicle stabilization.

In front of or behind the vehicle chassis 21 is a barrier 11 or containment blast plate 26, positioned upon status change to contain the projected fragmentation of IED/Mine, shockwave pressure and fire. Connecting the chassis to the blast plate is one variant of gas-fluid cartridges 29 with stepped release (0-200-800 lbs), which are body to plate connected, used as a dampening struts. All principles of recoil may be incorporated to dissipate the shockwave force resulting from the IED/Mine being triggered by any means known in the art. The entire assembly is tilted, raised and lowered for positioning and when not in use.

In another embodiment, a foil lever 30 creating a means of combined baffle and absorption are described. Within the stages of shock waves and fragmentation the blastplate is first moved rearward. In milliseconds after this action the pressure wave travels and strikes a plate of normal or curved geometry forming a foil and lever. As the pressure wave impinges upon the foil face it is pushed on the connected energy absorbing struts which are in turn connected to the rear blastplate or other containment space element. This arrangement of a foil lever may be organized in such a way in the containment space in any multiple of times in any suitable arrangement to maximize energy absorption. At the leading face of these foil levers may include a suitable face to reduce velocity to subsonic speeds. The foil, barrier or sandwich device angle may be adjusted at any angle to manage forces that will contribute to balancing the overall stability of the machine. The edge of barrier surfaces open to the blast wave ma may have a protruding bevel feature to initiate a downward force from the shockwave.

The billows 25 and curtain 25 are attached to supporting members, struts and assembled in accordion like manner on and along the sides forming a containment space for force protection for any fragmentation path. The billows and curtain may be composed of sandwich devices with holes. The canopy 24 is attached in a folded parachute manner. Both are of a blast resistant material such as carbon fiber or better. As the mine is triggered, the blast plate and vehicle are lifted and sent in different directions. The blast travel distance is slightly less in distance to the blast plate 26. Therefore, initially causes a reverse direction of the total assembly. Through this action and the gas-fluid cartridges 29, energy is dissipated with a reaction being centrally resisted by the mass and size of the total system.

As those reciprocating system parts that are in ground contact and as a reaction to the mine detonation, a feedback loop is broken and a fail-safe detection signal located along the feet is tripped on, when the connection is broken. The connecting arms are limit rated and are subject to the first and highest levels of stress. Upon the signal being sent to the optional gas ejection system 22, a propelled inert gas and fire suppression 23 system is activated for canopy deployment in an upward and reverse impulse direction.

In another embodiment during certain IED/Mine neutralization procedures the Explosive Ordnance Disposal (EOD) Specialists may benefit from defeating IED/Mines without triggering and detonating the target IED/Mine. As an alternative method for these tasks the procedure of subsuming the target threat may be utilized. This involves the use of detecting and uncovering the IED/Mine. Following this, the local adjacent are is enclosed by a canopy with a weighted canopy edge. Upon closing in the area and the above volume, the space is flooded with inert gas or gas fluid mixture while the neutralization procedure is being completed. By having the IED/Mine surfaces saturated by non-conductive fluids and removing oxygen in the enclosed environment, the nature and probability of the kinetic reaction is not present.

The canopy chute 24 path and speed is maximized upward for containment and canopy deployment from the top of assembly. A conventional set of three trailing hooks, left, center and right edges of the rear containment plate of the vehicle are employed to activate underground trigger mechanisms for offset hazards of aboveground, concealed mines.

In another embodiment, the canopy may have an intermediate or top section that is modified to mitigate the resulting pressure, fire and fragmentation. In this arrangement a single or multiple series of rectangular rings consisting of extensible rods, corner bars, and struts are used to form a strut ring. Other shapes to establish containment strut rings such as ovals, triangles, circles, polygons or curvilinear outlines are also possible. The resultant grouping from pressure wave reactions are established, the corresponding best shape fit which best dissipates the shock, pressure wave and fragmentation event.

The corners of the rectangle form reaction points. The corners have connectable ends which are able to make connection with pressure relieving struts 29, which may be telescopic. These components may be either for multiple use or replaceable. The principle of use is that the rectangles form a frame that the blast resistant material is connected onto in a billows curtain 25 method and the curtain is so connected, possibly unevenly pleated, from side to side, so as to slide along the lengths of the rectangle ring sides into a fully expanded manner. Therefore, as the canopy rectangle is propelled upward and subjected to any force, it has the ability to expand and be subjected to the stress and strain in the horizontal plane through the struts along the respective sides and further being contained by the expanding billows curtain sides. The unfolding nature of the canopy with the rectangular frames with struts included as described have the ability to be stacked in repetition.

As a later stage failsafe method of energy dissipation and to reduce the number of elements involved for energy dissipation, a top canopy breakaway section may be used. The principle of locating fragmentation baffles before top liftoff would provide a means of relieving overpressure with an overall smaller canopy.

A chute 50 may be introduced into the vehicle or robot chassis as a possible arrangement for gas and pressure flow. Chutes, Foils, tension bands and baffles are positioned to have the greatest effect to deflect and absorb energy and fragmentation. A chute through the chassis allows pressure and shock force to be bypassed to mitigate overturning the robot or vehicle.

A blast gate for any chute may be positioned at the entrance of a chute or foil. The gate acts as an initial pressure wave brake resisted by energy absorbing struts mounted to the gate plate and to the containment space. The gate orientation may be positioned so as to cause reactions from the pressure wave into the machine so as to absorb or contribute to stabilization. The chute may have a foil inside for reaction from lift. The concept of blast through structure provides for possibility of minimization of event reaction forces.

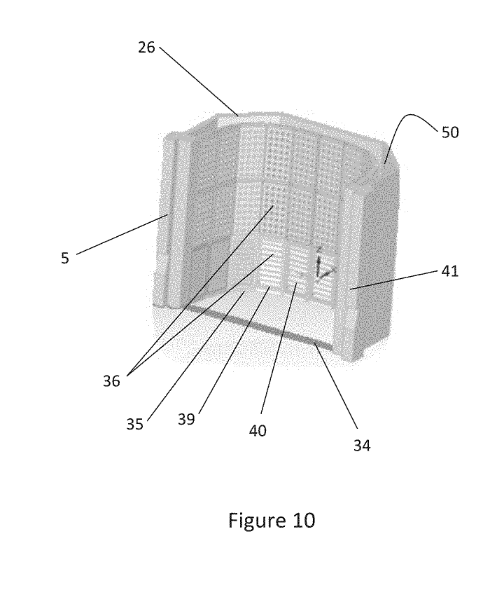

In a separate embodiment, a combined barrier protection element may be employed for vehicle and personnel protection and machine stabilizing and absorption requirements. The modular Fragmentation Protection Device, FIG. 10, provides simultaneous Force Protection from fragmentation and shockwaves caused by IED/Mines and rocket propelled grenades by deflecting energy, dissipating energy by flexing causing work-energy to be done and offset ignition by the outer layer. This barrier module may be raised, lowered, extend or tilted by actuators to deploy the device by remote control or be used as an autonomous robot. The connected sandwich devices may change profile shape and surface reflection characteristics as a jacket to form any curved shape necessary over the chassis. The jacket may be covered with a layer of density changing material known in the art.

The pressure wave acting upward and outward reacts against any surface in proximity. The containment space so proportioned with triggering mechanisms present, create contact surfaces. The net result is to cause instability and overturning to the vehicle or robot machine.

Edge angles of barrier sandwich devices and the chassis shell may have geometry set to deflect shockwave energy to cause reactions in the desired direction for chassis stability.

As the triggering takes place, staged reactions are started and the pressure wave comes into contact with the mechanisms. In order to further dissipate the energy from the leading shockwave, a magneto flux sandwich system may be used. In aim to balance all forces, it is advantageous to compensate for these forces. A series of blast resistant or conductive plates may be arranged in a sandwich configuration for an immediate impulse reaction. These sandwich assemblies may be sized, shaped, arranged and hinged in multiple positions in the containment zone so as to maximize energy dissipation and deflection. The entire assembly configuration may be fixed or shock strut connected to the vehicle or machine. Formations imparting couples into the frame may be realized. The system power source may be by an onboard generator and assisted from a gyro fitted for current generation. A current field is generated and wired to the system. The system comprises two or more rigid or semi rigid plates with conductive strips, poles or surfaces for providing current field induction. Permanent magnets may be incorporated into the plate surface. Each surface is connected so as to allow limited freedom of movement out of plane as well as in plane, each surface forming a plate that has any array of openings. These openings and ducts function with or without field generated. The openings may be sized with a specific aperture and sidewall cut to maximize the effects of shockwave deflection and collapse of shockwave gas density.

The complimentary offset plate or surface has a mated array of openings which may contain an inverted or planar opposite set of shaped ducts. The planar angle of each duct acts to maximize the effect of energy deflection and pressure wave reduction. As a second stage to the system, the surfaces or plates may be conductive so as create a magnetic field for attractive or repulsive force which may be from permanent magnets or electromagnetic means. The magnetic field and corresponding magnetic flux may be varied and is provided at a desired strength for resistance, opening and or closing and may be area attenuated. The plate movement action may be actuated from voltage from a capacitor source. The plates may be layered with dielectric material so as to maximize repulsion and attraction effects. The plates may be held at a distance relative to another mechanically or with a flexible hinge. The sandwich assembly edges may have pleated flexible connections forming an unfolding shock linkage. Each plate may have any percentage of surface area open for pressure wave passage.

In one reaction case, the pressure field strikes the first plate and is pressed towards the secondary plate. As this motion takes place the magnetic field between the two plates is turned on, the plates acting into the direction of the pressure wave. In another reaction case, a second plate, having complimentary meshed ducts, is repulsed with sufficient flux density. As the pressure wave impacts the primary front plate the magnetic field is closed and the plates slam together. In both cases the opening or closing of the plates with the corresponding openings and ducts deflects and diverts pressure wave forces. The ducts may be aligned in any pattern so as create an overall reaction for the sandwich device according to the orientation of the barrier device to the point of origin. Further reaction force can be provided by the use of pressure sensitive encased charges 34 at the bottom of each port stub. The total amount of reaction force can be staged to react to the uplift force encountered.

The surface of the plates may include notched abraded surfaces with very small holes possibly laser cut at a predetermined angle to cause defection of energy in the desired direction. The space between plates may have absorptive material layers lined. A plate may have no openings. A third plate may be sandwiched for additional strength and dissipating effects. In order to improve the plate deflection characteristics, the use of baffles creating a leading layer of suitable material strength may be placed in front of the plates. The sandwich assemblies may have internal baffles configured to further block fragmentation. Sensors, pressure transducers and relays may be used to control any advance or delay required to optimize controlling change of the flux density of the magnetic field in the system.

The combined components are so arranged to dissipate the energy field with respect to its vector and by stage of the mine event and respond in a predetermined and controlled manner. A split blast plate with pressure struts can be used. As is the case with many structures that may encounter pressure waves, dissipating, collapsible and compressible medium in layers may contribute to protection of the intended space and surfaces or vacuum control volume may be incorporated on the surfaces or within the containment space in order to mitigate forces to be resisted or deflected. Each of the absorbing elements and mechanism are positioned and analyzed in a global vector summary around the machine centroid to arrive at the best use to resolve the set of forces to achieve overall stability.

A centerline path marking system may be mounted at the rear of vehicle with specialized material/paint at coded spaced intervals. The system also automatically paints low spots and where not proofed, unchecked or for skipped locations. The vehicle carries a remote deployed warning flag system inside of, on the top of or on the side of the chassis or vehicle. Any flag or marking system known in the art may be used. Trailing hooks may be positioned for drag wires present but not detected.

Through the progress of technology, the geometry and configuration of machine structure and components may be more streamlined and efficient. This process of development may include the energy dissipation, force balancing and containment elements being located anywhere in or through the structure, possibly within the wheelbase. The methods and applications stated herein apply science and engineering for a vehicle, machine, robot or structure, modules, components and devices to achieve IED/Mine detection, triggering, absorb energy from resulting blast shockwave and contain fragmentation for Force Protection.

The invention has been described with respect to particular embodiments. Modifications and substitutions within the spirit and scope of the invention will be apparent to those of skill in the art. Of particular benefit is the instantaneous effect of a shockwave impinging on surfaces with the impulse oriented by the incident angle of the shockwave being normal to surfaces resulting in downward reactions as demonstrated in numerous previous experiments. The chassis with lateral thrust wheel system provides a landing capability in shore areas with waves. The cleared path width may be adjusted as the technology presented is scalable for modular application. Individual elements identified herein as belonging to a particular embodiment, may be included in other embodiments of the invention as well.

The present invention may be embodied in other specific forms without departing from the attributes herein described. The illustrated embodiments and examples of use should be considered in all respects as examples and illustrative and not restrictive. The devices described herein, individually or in combination may be advantageously be fixed as attachments for or onto other vehicles to achieve desired results which are intended or needed the mechanisms may be further integrated into robot chassis or vehicles.

What is Claimed:

1) A method combining navigating in water and traversing land comprising:
a) using an unmanned ground vehicle with traction components able to traverse said land;
wherein said traction components are robotically controlled by actuators to raise or lower the chassis and;
b) providing a means for thru chassis water propulsion.

2) The method of claim 1 further comprising a fragmentation barrier system for Force Protection.

3) The method of claim 1 further comprising detonating the IED/Mine remotely.

4) The method of claim 1 further comprising detecting and detonating IED/Mines autonomously.

5) The method of claim 1 further comprising an onboard computer and actuators to navigate or traverse land as an autonomous robot.

6) A method combining navigating in water and traversing land comprising:
a) using an unmanned ground vehicle with traction components able to traverse said land;
wherein said traction components are robotically controlled by actuators to inflate tire sections and;
b) providing a wheel vane configuration for thru-wheel water propulsion through said wheel.

7) A method of safe passage for humans and equipment comprising:
a) using composite blast resistant material forming a modular mat system; and
said modular system having a perimeter inflatable and deflating float system.

8) The method of claim 7 further comprising a composite system of blast sandwich assemblies having two or more blast resistant plates with space between said plates and at least one said plate having multiple openings;
said plate openings having internally aligned ducts suitably fashioned to deflect energy;
said assemblies are end to end connected and form at least one row; and
wherein said plates are connected at edges.

9) The method of claim 7 further comprising an internal set of transponders for mine detection.

10) The method of claim 8 further comprising said sandwich assembly edges with pleated flexible connections forming an unfolding shock linkage.
